(19) United States
(12) Patent Application Publication
(10) Pub. No.: US 2025/0309543 A1
(43) Pub. Date: Oct. 2, 2025

(54) ELECTRONIC DEVICE AND ANTENNA MODULE

(71) Applicant: WISTRON NEWEB CORPORATION, HSINCHU (TW)

(72) Inventors: JIAN-ZHONG CHEN, HSINCHU (TW); CHENG-WEI CHIANG, HSINCHU (TW); MENG-KAI WU, HSINCHU (TW); PAO-CHUAN PENG, HSINCHU (TW)

(21) Appl. No.: 18/791,590

(22) Filed: Aug. 1, 2024

(30) Foreign Application Priority Data
Apr. 1, 2024 (TW) 113112254

(51) Int. Cl. H01Q 9/04; G01D 5/24; H01Q 1/22

(52) U.S. Cl. CPC H01Q 9/0442; G01D 5/24; H01Q 1/2266; H01Q 9/0421; H01Q 9/0457

(57) ABSTRACT

An electronic device includes a housing and an antenna module. The antenna module is disposed in the housing. The antenna module includes a feeding radiation element, a switching circuit, a radiating element, and a floating radiation element. The feeding radiation element is electrically connected to a feeding element. The feeding radiation element includes a first radiating portion. The radiating element is electrically connected to the switching circuit. The radiating element and the first radiating portion are separated from and coupled with each other. The floating radiation element and the radiating element are separated from and coupled to each other. The floating radiation element and the switching circuit are separated from each other.

### CROSS-REFERENCE TO RELATED PATENT APPLICATION

This application claims the benefit of priority to Taiwan Patent Application No. 113112254, filed on Apr. 1, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electronic device and an antenna module, and more particularly to an antenna module capable of covering multiple frequency bands and an electronic device having the antenna module.

### BACKGROUND OF THE DISCLOSURE

Currently, exterior designs of electronic devices, such as notebook computers, are developed toward being thinner and more lightweight, while needing to maintain high levels of performance. Since there is a tendency for an outer appearance of a notebook computer to be designed with a narrow screen frame, an internal space of the notebook computer that is available for placement of an antenna is very limited. Thus, the antenna is likely to have an issue of decreasing or insufficient bandwidth under these circumstances.

Therefore, how to design an antenna structure capable of simultaneously transmitting and receiving multiple wireless frequency bands and having good antenna efficiency within the limited internal space of the electronic device has become an important issue to be addressed in the related art.

### SUMMARY OF THE DISCLOSURE

In response to the above-referenced technical inadequacy, the present disclosure provides an electronic device and an antenna module, which can address an issue of the antenna module not having a sufficient bandwidth due to miniaturization requirements of the electronic device.

In order to solve the above-mentioned problems, one of the technical aspects adopted by the present disclosure is to provide an electronic device, which includes a housing and an antenna module. The antenna module is disposed in the housing. The antenna module includes a feeding radiation element, a switching circuit, a radiating element, and a floating radiation element. The feeding radiation element is electrically connected to a feeding element. The feeding radiation element includes a first radiating portion. The radiating element is electrically connected to the switching circuit. The radiating element and the first radiating portion are separated from and coupled with each other. The floating radiation element and the radiating element are separated from and coupled to each other. The floating radiation element and the switching circuit are separated from each other.

In order to solve the above-mentioned problems, another one of the technical aspects adopted by the present disclosure is to provide an antenna module, which includes a feeding radiation element, a switching circuit, a radiating element, and a floating radiation element. The feeding radiation element is electrically connected to a feeding element. The feeding radiation element includes a first radiating portion. The radiating element is electrically connected to the switching circuit. The radiating element and the first radiating portion are separated from and coupled with each other. The floating radiation element and the radiating element are separated from and coupled to each other. The floating radiation element and the switching circuit are separated from each other.

Therefore, in the electronic device and the antenna module thereof provided by the present disclosure, by virtue of the radiating element being electrically connected to the switching circuit, the radiating element and the first radiating portion being separated from and coupled with each other, and the floating radiation element and the radiating element being separated from and coupled with each other, a dual coupling path can be formed in the antenna module. Therefore, by the dual coupling paths being switched through the switching circuit, the antenna module can have a broader bandwidth performance in the low frequency range.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an electronic device according to the present disclosure;

FIG. 2 is a schematic view of an antenna module according to a first embodiment of the present disclosure;

FIG. 3 is a schematic enlarged view of part III of FIG. 2;

FIG. 4 is a schematic view of a switching circuit of the antenna module according to the present disclosure;

FIG. 5 is a schematic view of another implementation of the antenna module according to the first embodiment of the present disclosure;

FIG. 6 is a schematic view of an antenna module according to a second embodiment of the present disclosure;

FIG. 7 is a schematic enlarged view of part VII of FIG. 6; and

FIG. 8 is a curve diagram showing return loss of the antenna module according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In addition, the term “connect” or “connected” in the context of the present disclosure means that there is a physical connection between two elements, and the two elements are directly or indirectly connected. The term “couple” or “coupled” in the context of the present disclosure means that two elements are separate from each other and have no physical connection therebetween, and an electric field energy generated by one of the two elements excites an electric field energy generated by another one of the two elements.

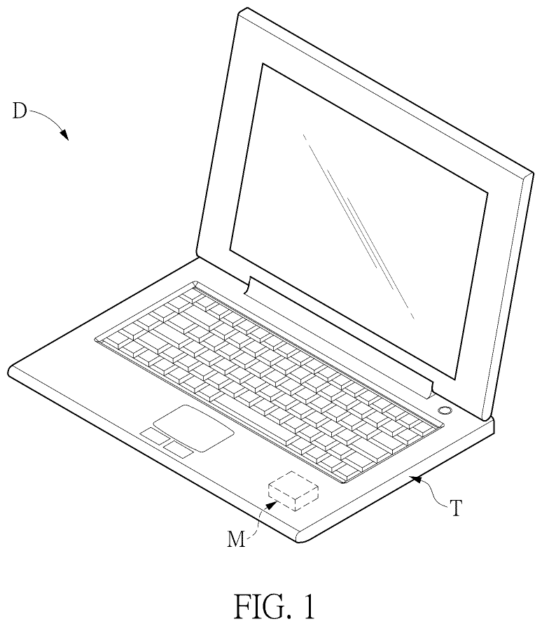

Reference is made to FIG. 1, which is a schematic view of an electronic device according to the present disclosure. The present disclosure provides an electronic device D, which includes a housing T and an antenna module M that is disposed in the housing T. The electronic device D can be a smart phone, a tablet computer, or a laptop computer. However, the present disclosure is not limited thereto. In the present disclosure, the electronic device D is exemplified as the laptop computer. At least one part of the housing T can be a metal housing. The position and quantity of the antenna module M in the electronic device D are not limited in the present disclosure.

### First Embodiment

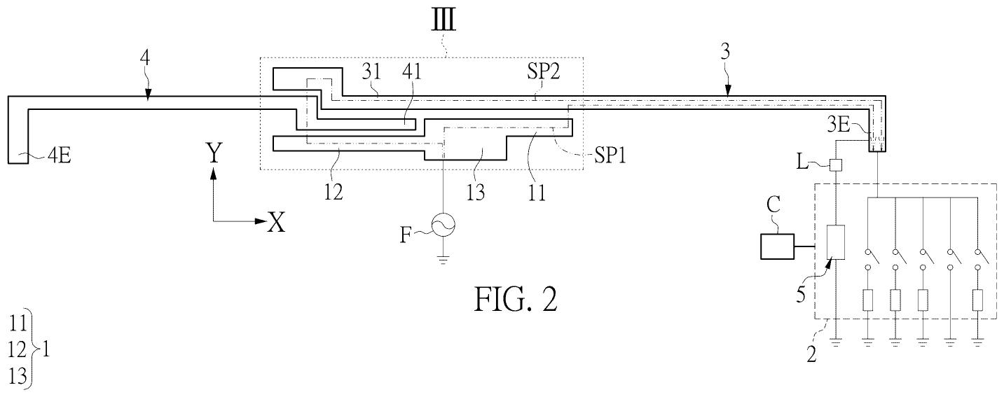

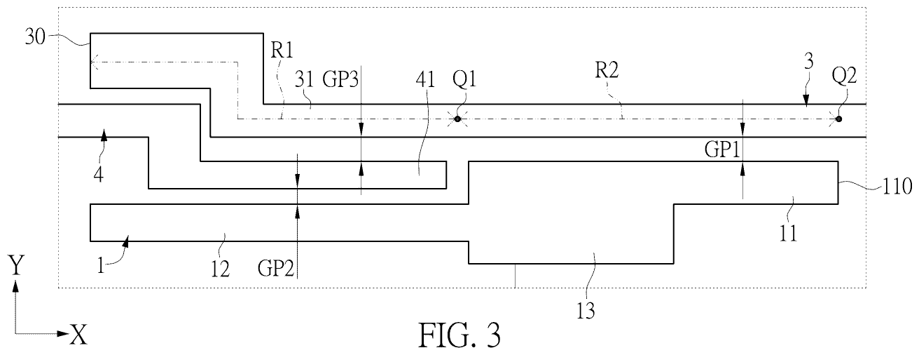

Reference is made to FIG. 2 and FIG. 3. FIG. 2 is a schematic view of an antenna module according to a first embodiment of the present disclosure, and FIG. 3 is a schematic enlarged view of part III of FIG. 2. The first embodiment of the present disclosure provides an antenna module M, which includes a feeding radiation element 1, a switching circuit 2, a radiating element 3, and a floating radiation element 4. The feeding radiation element 1 is electrically connected to a feeding element F. The radiating element 3 is electrically connected to the switching circuit 2, and the floating radiation element 4 and the switching circuit 2 are separated from each other. The feeding radiation element 1, the radiating element 3, and the floating radiation element 4 are separated from and not in contact with each other.

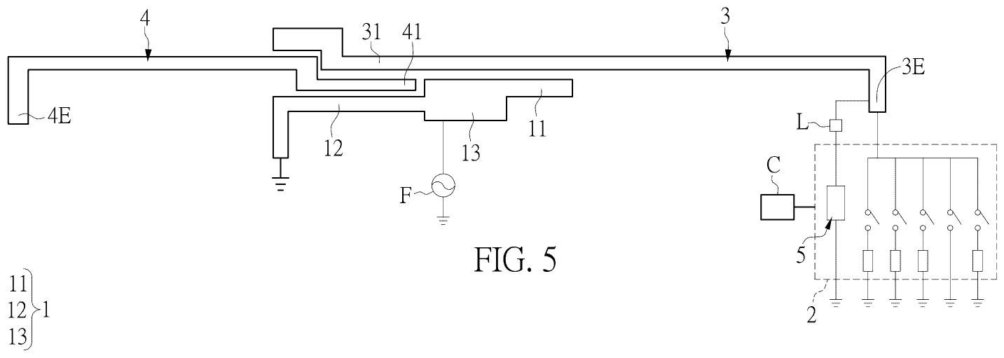

The feeding radiation element 1 includes a first radiating portion 11, a second radiating portion 12, and a feeding portion 13. The feeding portion 13 is connected to the first radiating portion 11 and the second radiating portion 12. The feeding portion 13 is electrically connected to the feeding element F, and the feeding element F feeds a signal through the feeding portion 13. Specifically, the feeding portion 13 is connected between the first radiating portion 11 and the second radiating portion 12. The first radiating portion 11 and the second radiating portion 12 extend along different directions relative to the feeding portion 13. A length of the first radiating portion 11 is different from a length of the second radiating portion 12. The feeding radiation element 1 can be, for example, a monopole antenna, but the present disclosure is not limited thereto. Reference is made to FIG. 5, which is a schematic view of another implementation of the antenna module according to the first embodiment of the present disclosure. As shown in FIG. 5, the second radiating portion 12 is grounded, such that the feeding radiation element 1 forms a planar inverted-F antenna.

A part of the floating radiation element 4, which is defined as an extension portion 41, extends between the radiating element 3 and the second radiating portion 12 of the feeding radiation element 1. The radiating element 3 has two ends. One end of the radiating element 3 is a connection end 3E that is electrically connected to the switching circuit 2. Another end of the radiating element 3 extends toward the feeding radiation element 1 and the floating radiation element 4, such that a part of the radiating element 3, which is defined as an extension portion 31, is located directly above the feeding radiation element 1 and the extension portion 41. Therefore, the radiating element 3 and the first radiating portion 11 of the feeding radiation element 1 are coupled to each other, the extension portion 41 of the floating radiation element 4 and the extension portion 31 of the radiating element 3 are coupled to each other, and the extension portion 41 of the floating radiation element 4 and the second radiating portion 12 of the feeding radiation element 1 are coupled to each other.

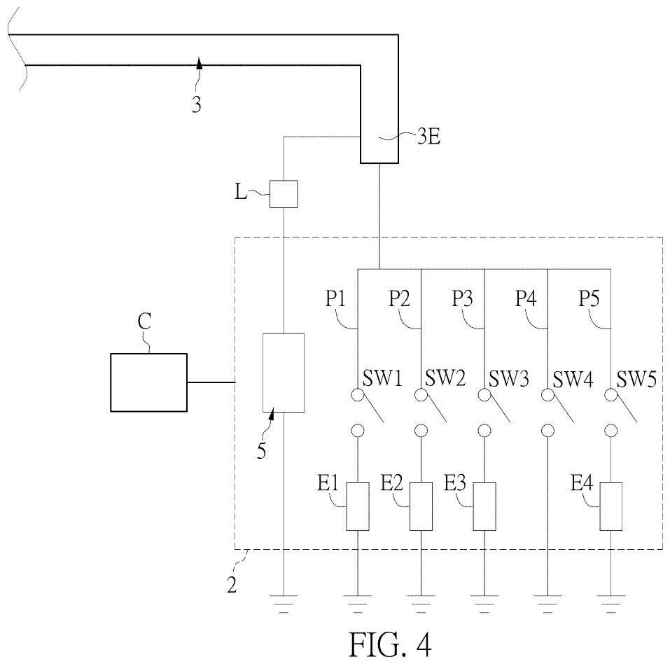

Reference is made to FIG. 4, which is a schematic view of a switching circuit of the antenna module according to the present disclosure. The switching circuit 2 can include a one or more paths, and the present disclosure is not limited thereto. For example, the switching circuit 2 includes a first path P1, a second path P2, a third path P3, a fourth path P4, and a fifth path P5. The first path P1 has a first switch SW1, the second path P2 has a second switch SW2, the third path P3 has a third switch SW3, the fourth path P4 has a fourth switch SW4, and the fifth path P5 has a fifth switch SW5.

The first path P1 further includes a first passive element E1, the second path P2 further includes a second passive element E2, the third path P3 further includes a third passive element E3, and the fifth path P5 further includes a fourth passive element E4. In response to different switches being turned on or off, the switching circuit 2 is switched among various modes. For instance, in response to the first switch SW1 and the second switch SW2 being turned on or off, the switching circuit 2 is switched to a first mode or a second mode. Moreover, an equivalent impedance of the switching circuit 2 in the first mode is different from the equivalent impedance of the switching circuit 2 in the second mode. In addition, each of the first passive element E1, the second passive element E2, the third passive element E3, and the fourth passive element E4 can be, for example, an inductor, a resistor, or a capacitor. In the present disclosure, each of the first passive element E1, the second passive element E2, and the third passive element E3 is the capacitor, and a capacitance of each of the first passive element E1, the second passive element E2, and the third passive element E3 ranges from 1 pF to 150 pF. The fourth passive element E4 is the inductor, and an inductance of the fourth passive element E4 ranges from 1 nH to 250 nH.

Reference is further made to FIG. 2. In the medium and high frequency ranges generated by antenna module M, the signal provided by the feeding element F is fed into the feeding portion 13, and the feeding portion 13 and the first radiating portion 11 are excited to generate an operating frequency band from 5,000 MHz to 6,000 MHz, and the feeding portion 13 and the second radiating portion 12 are excited to generate an operating frequency band from 3,000 MHz to 5,000 MHz. Furthermore, through the coupling between the second radiating portion 12 and the extension portion 41 of the floating radiation element 4, the signal provided by the feeding element F can be transmitted to an end point 4E of the floating radiation element 4 through the second radiating portion 12 and the extension portion 41, such that the feeding portion 13, the second radiating portion 12, and the floating radiation element 4 jointly generate an operating frequency band from 1,400 MHz to 2,690 MHz.

Reference is further made to FIG. 2. In the low frequency ranges generated by antenna module M, when the switching circuit 2 does not work, that is, all switches in the switching circuit 2 are in a non-conducting state, the signal provided by the feeding element F can be transmitted to the connection end 3E through a first signal transmission path SP1 to generate an operating frequency band from 800 MHz to 880 MHz. The components constituting the first signal transmission path SP1 include the feeding portion 13, the first radiating portion 11, and a part of the radiating element 3.

When the switching circuit 2 works, that is, at least one switch in the switching circuit 2 is in a conducting state, the signal provided by the feeding element F can be transmitted to the connection end 3E through a second signal transmission path SP2, and then enters into the switching circuit 2. The components constituting the second signal transmission path SP2 include the feeding portion 13, the second radiating portion 12, the extension portion 41 of the floating radiation element 4, and the radiating element 3 in a sequence of the feeding element F to the connection end 3E. Moreover, as shown in FIG. 2, a length of the first signal transmission path SP1 is different from a length of the second signal transmission path SP2.

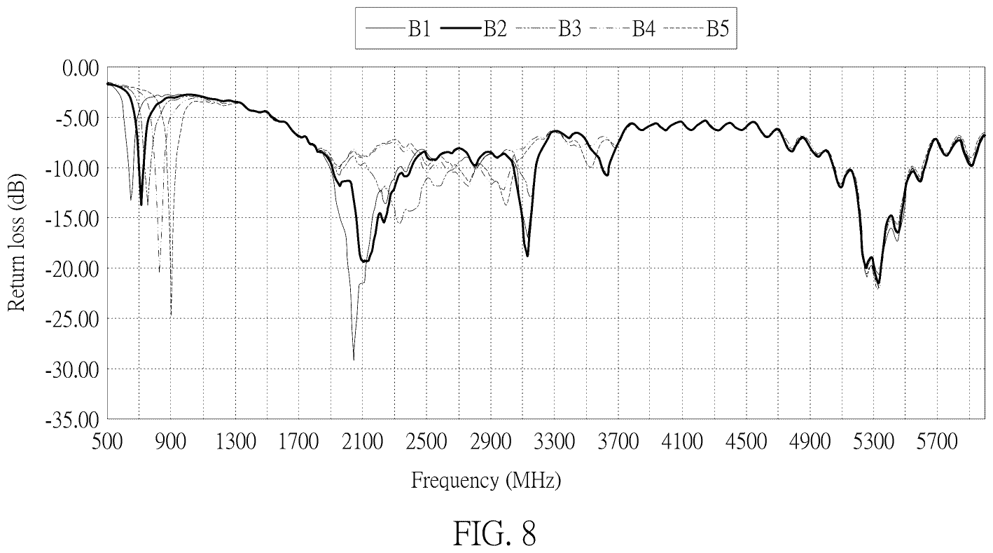

Reference is made to FIGS. 2, 4, and 8. FIG. 8 is a curve diagram showing return loss of the antenna module according to the present disclosure. For example, in response to the switching circuit 2 being switched to a first mode B1, the first switch SW1 is in a conducting state and the other switches are in a non-conducting state, the signal enters into the switching circuit 2 through the second signal transmission path SP2, and passes through the first path P1 and the first passive element E1 to generate an operating frequency band of 617 MHz to 698 MHz. In response to the switching circuit 2 being switched to a second mode B2, the second switch SW2 is in a conducting state and the other switches are in a non-conducting state, the signal enters into the switching circuit 2 through the second signal transmission path SP2, and passes through the second path P2 and the second passive element E2 to generate an operating frequency band of 698 MHz to 756 MHz.

In response to the switching circuit 2 being switched to a third mode B3, the third switch SW3 is in a conducting state and the other switches are in a non-conducting state, the signal enters into the switching circuit 2 through the second signal transmission path SP2, and passes through the third path P3 and the third passive element E3 to generate an operating frequency band of 746 MHz to 803 MHz. In response to the switching circuit 2 being switched to a fourth mode B4, the fourth switch SW4 is in a conducting state and the other switches are in a non-conducting state, the signal enters into the switching circuit 2 through the second signal transmission path SP2, and passes through the fourth path P4 to generate an operating frequency band of 791 MHz to 894 MHz. In response to the switching circuit 2 being switched to a fifth mode B5, the fifth switch SW5 is in a conducting state and the other switches are in a non-conducting state, the signal enters into the switching circuit 2 through the second signal transmission path SP2, and passes through the fifth path P5 and the fourth passive element E4 to generate an operating frequency band of 880 MHz to 960 MHz.

Reference is made to FIG. 8. When the switching circuit 2 is switched among the first mode B1, the second mode B2, and the third mode B3, the low frequency band generated by the antenna module M shifts to 617 MHz through the design of the first path P1 to the third path P3 connecting the capacitors. When the switching circuit 2 is switched among the fourth mode B4 and the fifth mode B5, the low frequency band generated by the antenna module M shifts to 960 MHz through the design of connecting the fourth path P4 without capacitors and the fifth path P5 with the inductor. In addition, when the low frequency band generated by the antenna module M is adjusted by the switching circuit, the medium and high frequency characteristics generated by the antenna module M are not affected. Therefore, through structural design of the dual low-frequency coupling paths (i.e., the first signal transmission path SP1 and the second signal transmission path SP2), in conjunction with the switching circuit 2, the antenna module M can have a broader bandwidth performance in the low frequency range, thereby covering the low frequency range from 617 MHz to 960 MHz. As shown in FIG. 2 and FIG. 4, the electronic device D further includes a control circuit C, and the control circuit C can control the switching circuit 2 to switch among various modes and adjust the operating frequency bands generated by the antenna structure M.

Reference is further made to FIG. 2 and FIG. 3. The second radiating portion 12 and the floating radiation element 4 are located at one side of the feeding element F (i.e., left side of the feeding element F), and the first radiating portion 11 is located at another side of the feeding element F (i.e., right side of the feeding element F). Furthermore, the radiating element 3 includes a first branch R1 and a second branch R2. The radiating element 3 is coupled to the floating radiation element 4 through the first branch R1, and the radiating element 3 is coupled to the first radiating portion 11 and the feeding portion 13 through the second branch R2.

A length of the first branch R1 refers to a length from an open end 30 of the radiating element 3 to a first point Q1, and the first point Q1 is located between the extension portion 41 and the feeding portion 13 in an X-axis direction. For example, the length of the first branch R1 is between 0.2 and 0.3 times the length of the radiating element 3. Through the length design of the first branch R1, the mode generated by the second signal transmission path SP2 can have wideband effects, and the radiating element 3 can achieve impedance matching.

A length of the second branch R2 refers to a length from the first point Q1 to a second point Q2, and the second point Q2 is aligned with an open end 110 of the first radiating portion 11 in Y-axis direction. For example, the length of the second branch R2 is between 0.15 and 0.25 times the length of the radiating element 3. Through the length design of the second branch R2, the mode generated by the first signal transmission path SP1 can have wideband effects, and the radiating element 3 can achieve impedance matching.

Reference is further made to FIG. 3. The radiating element 3 and the first radiating portion 11 of the feeding radiation element 1 have a first coupling gap GP1 therebetween. The extension portion 41 of the floating radiation element 4 and the second radiating portion 12 of the feeding radiation element 1 have a second coupling gap GP2 therebetween. The extension portion 41 of the floating radiation element 4 and the extension portion 31 of the radiating element 3 have a third coupling gap GP3 therebetween. For example, the first coupling gap GP1 ranges from 0.1 mm and 3 mm, the second coupling gap GP2 ranges from 0.05 mm and 2 mm, and the third coupling gap GP3 ranges from 0.1 mm and 3 mm. The first coupling gap GP1 can adjust the impedance matching of the antenna module M between 5,000 MHz and 6,000 MHz, and the second coupling gap GP2 and the third coupling gap GP3 can adjust the impedance matching of the antenna module M between 1,400 MHz and 5,000 MHz, thereby improving the medium and high frequency characteristics of the antenna.

Moreover, the radiating element and the radiating portion corresponding to each coupling gap can be disposed on different planes. For example, the first radiating portion 11 and the radiating element corresponding to the first coupling gap GP1 can be disposed on different planes. The second radiating portion 12 and the extension portion 41 corresponding to the second coupling gap GP2 can be disposed on different planes. The extension portion 31 and the extension portion 41 corresponding to the third coupling gap GP3 can be disposed on different planes. In addition, the second coupling gap GP2 and the third coupling gap GP3 are located at one side of the feeding element F (i.e., left side of the feeding element F), and the first coupling gap GP1 is located at another side of the feeding element F (i.e., right side of the feeding element F).

Reference is further made to FIG. 2. The electronic device D further includes an inductor L and a proximity sensing circuit 5. The proximity sensing circuit 5 is electrically connected to the radiating element 3, and the inductor L is electrically connected between the radiating element 3 and the proximity sensing circuit 5. The inductor L can serve as a RF choke to prevent a RF signal generated in the antenna module M from flowing into the proximity sensing circuit 5. For example, the proximity sensing circuit 5 can be a capacitance sensing circuit and the radiating element 3 can serve as a sensor electrode, which can be utilized by the proximity sensing circuit 5 to measure the capacitance. The control circuit C can be used to determine whether or not a human body is in close proximity of the antenna module M through the change in capacitance value sensed by the proximity sensing circuit 5. In addition, in the embodiments of the present disclosure, the proximity sensing circuit 5 is integrated into the switching circuit 2, and the present disclosure is not limited thereto. In other embodiments, the proximity sensing circuit 5 can be disposed outside the switching circuit 2.

### Second Embodiment

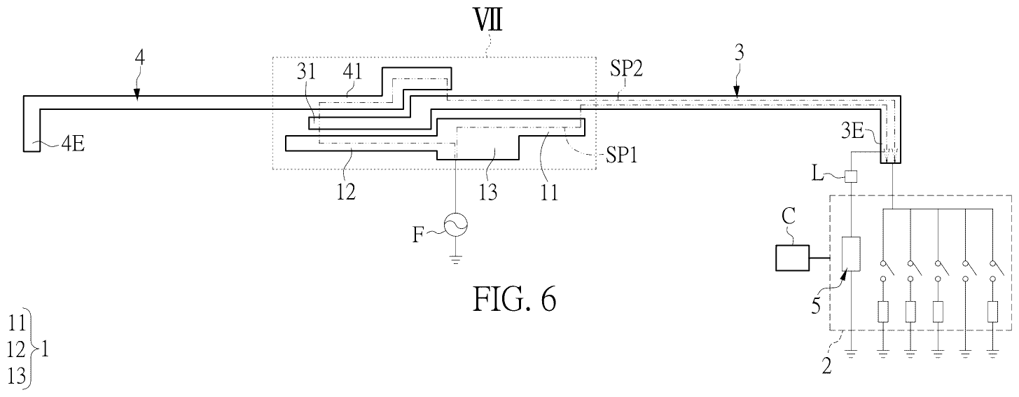

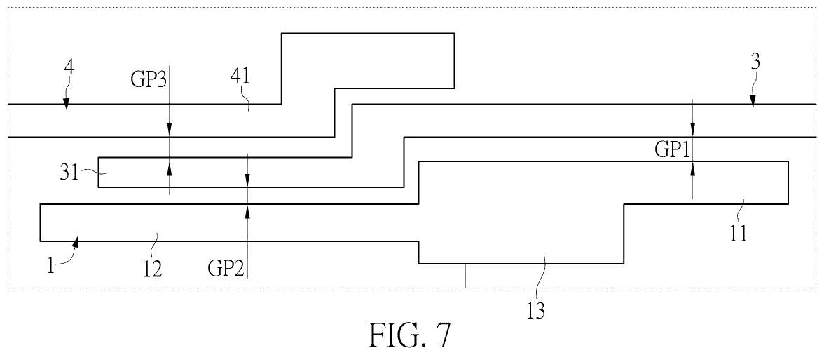

Reference is made to FIG. 6 and FIG. 7. FIG. 6 is a schematic view of an antenna module according to a second embodiment of the present disclosure. FIG. 7 is a schematic enlarged view of part VII of FIG. 6. The second embodiment of the present disclosure provides an antenna module M, which includes a feeding radiation element 1, a switching circuit 2, a radiating element 3, and a floating radiation element 4. The antenna structure M of the second embodiment has a structure similar to that of the first embodiment, and the similarities therebetween will not be reiterated herein. The main difference between the second embodiment and the first embodiment is that the relative positions between the feeding radiation element 1, the radiating element 3, and the floating radiation element 4 are different. Specifically, in the second embodiment, the extension portion 31 of the radiating element 3 extends between the extension portion 41 of the floating radiation element 4 and the second radiating portion 12 of the feeding radiation element 1. The extension portion 41 of the floating radiation element 4 is located directly above the extension portion 31 of the radiating element 3. Therefore, the extension portion 31 of the radiating element 3 and the extension portion 41 of the floating radiation element 4 are coupled to each other, and the extension portion 31 of the radiating element 3 and the second radiating portion 12 of the feeding radiation element 1 are coupled to each other.

Reference is further made to FIG. 7. In the second embodiment, the radiating element 3 and the first radiating portion 11 of the feeding radiation element 1 have a first coupling gap GP1 therebetween. The extension portion 31 of the radiating element 3 and the second radiating portion 12 have a second coupling gap GP2 therebetween. The extension portion 31 of the radiating element 3 and the floating radiation element 4 have a third coupling gap GP3 therebetween. For example, the second coupling gap GP2 ranges from 0.05 mm and 2 mm, and the third coupling gap GP3 ranges from 0.1 mm and 3 mm.

Since the structural configuration of the antenna module M in the second embodiment is different from that of the first embodiment, the sequence of the components by which the signal is transmitted to the connection end 3E through the second signal transmission path SP2 in the second embodiment is different from that of the first embodiment. As shown in FIG. 6, the components constituting the second signal transmission path SP2 include the feeding portion 13, the second radiating portion 12, the extension portion 31 of the radiating element 3, a part of the floating radiation element 4 located directly above the extension part 31, and a remaining part of the radiating element 3 except the extension portion 31.

### BENEFICIAL EFFECTS OF THE EMBODIMENTS

In conclusion, in the electronic device and the antenna module thereof provided by the present disclosure, by virtue of the radiating element being electrically connected to the switching circuit, the radiating element and the first radiating portion being separated from and coupled with each other, and the floating radiation element and the radiating element being separated from and coupled with each other, the dual coupling path can be formed in the antenna module. Therefore, through the structural design of the dual low-frequency coupling paths (i.e., the first signal transmission path SP1 and the second signal transmission path SP2), in conjunction with the switching circuit 2, the antenna module M can have wideband performance in the low frequency range, thereby covering the low frequency range from 617 MHz to 960 MHz. In addition, when the low frequency band generated by the antenna module M is adjusted by the switching circuit, the medium and high frequency characteristics generated by the antenna module M are not affected.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electronic device, comprising:
a housing; and
an antenna module disposed on the housing and including:
a feeding radiation element electrically connected to a feeding element, wherein the feeding radiation element includes a first radiating portion;
a switching circuit;
a radiating element electrically connected to the switching circuit, wherein the radiating element and the first radiating portion are separated from and coupled with each other; and
a floating radiation element separated from and coupled with the radiating element, wherein the floating radiation element and the switching circuit are separated from each other.

2. The electronic device according to claim 1, wherein the feeding radiation element further includes a second radiating portion, a part of the floating radiation element is located between the radiating element and the second radiating portion, and the part of the floating radiation element is separated from and coupled with the radiating element and the second radiating portion.

3. The electronic device according to claim 2, wherein the radiating element and the first radiating portion have a first coupling gap therebetween, and the first coupling gap ranges from 0.1 mm and 3 mm; wherein the part of the floating radiation element and the second radiating portion have a second coupling gap therebetween, and the second coupling gap ranges from 0.05 mm and 2 mm; wherein the floating radiation element and the radiating element have a third coupling gap therebetween, and the third coupling gap ranges from 0.1 mm and 3 mm.

4. The electronic device according to claim 1, wherein the feeding radiation element further includes a second radiating portion, a part of the radiating element is located between the floating radiation element and the second radiating portion, and the part of the radiating element is separated from and coupled with the floating radiation element and the second radiating portion.

5. The electronic device according to claim 4, wherein the radiating element and the first radiating portion have a first coupling gap therebetween, and the first coupling gap ranges from 0.1 mm and 3 mm; wherein the part of the radiating element and the second radiating portion have a second coupling gap therebetween, and the second coupling gap ranges from 0.05 mm and 2 mm; wherein the part of the radiating element and the floating radiation element have a third coupling gap therebetween, and the third coupling gap ranges from 0.1 mm and 3 mm.

6. The electronic device according to claim 1, wherein the radiating element includes a connection end, the radiating element is electrically connected to the switching circuit through the connection end, the feeding radiation element further includes a feeding portion and a second radiating portion, the feeding portion is connected to the first radiating portion and the second radiating portion, and the feeding element feeds a signal through the feeding portion; wherein the signal is transmitted to the connection end through a first signal transmission path, and the first signal transmission path includes the feeding portion, the first radiating portion, and the radiating element; wherein the signal is transmitted to the connection end through a second signal transmission path, the second signal transmission path includes the feeding portion, the second radiating portion, the radiating element, and the floating radiation element, and a length of the first signal transmission path is different from a length of the second signal transmission path.

7. The electronic device according to claim 1, wherein the switching circuit includes a first path, and the first path has a first switch.

8. The electronic device according to claim 7, wherein the first path further includes a first passive element, the switching circuit further includes a second path, and the second path has a second switch and a second passive element; wherein, in response to the first switch and the second switch being turned on or off, the switching circuit is switched to a first mode or a second mode; wherein an equivalent impedance of the switching circuit in the first mode is different from an equivalent impedance of the switching circuit in the second mode.

9. The electronic device according to claim 1, further comprising a proximity sensing circuit, wherein the proximity sensing circuit is electrically connected to the radiating element.

10. An antenna module, comprising:
a feeding radiation element electrically connected to a feeding element, wherein the feeding radiation element includes a first radiating portion;
a switching circuit;
a radiating element electrically connected to the switching circuit, wherein the radiating element and the first radiating portion are separated from and coupled with each other; and
a floating radiation element separated from and coupled with the radiating element, wherein the floating radiation element and the switching circuit are separated from each other.

11. The antenna module according to claim 10, wherein the feeding radiation element further includes a second radiating portion, a part of the floating radiation element is located between the radiating element and the second radiating portion, and the part of the floating radiation element is separated from and coupled with the radiating element and the second radiating portion.

12. The antenna module according to claim 11, wherein the radiating element and the first radiating portion have a first coupling gap therebetween, and the first coupling gap ranges from 0.1 mm and 3 mm; wherein the part of the floating radiation element and the second radiating portion have a second coupling gap therebetween, and the second coupling gap ranges from 0.05 mm and 2 mm; wherein the floating radiation element and the radiating element have a third coupling gap therebetween, and the third coupling gap ranges from 0.1 mm and 3 mm.

13. The antenna module according to claim 10, wherein the feeding radiation element further includes a second radiating portion, a part of the radiating element is located between the floating radiation element and the second radiating portion, and the part of the radiating element is separated from and coupled with the floating radiation element and the second radiating portion.

14. The antenna module according to claim 13, wherein the radiating element and the first radiating portion have a first coupling gap therebetween, and the first coupling gap ranges from 0.1 mm and 3 mm; wherein the part of the radiating element and the second radiating portion have a second coupling gap therebetween, and the second coupling gap ranges from 0.05 mm and 2 mm; wherein the part of the radiating element and the floating radiation element have a third coupling gap therebetween, and the third coupling gap ranges from 0.1 mm and 3 mm.

15. The antenna module according to claim 10, wherein the radiating element includes a connection end, the radiating element is electrically connected to the switching circuit through the connection end, the floating radiation element further includes a feeding portion and a second radiating portion, the feeding portion is connected to the first radiating portion and the second radiating portion, and the feeding element feeds a signal through the feeding portion; wherein the signal is transmitted to the connection end through a first signal transmission path, and the first signal transmission path includes the feeding portion, the first radiating portion, and the radiating element; wherein the signal is transmitted to the connection end through a second signal transmission path, the second signal transmission path includes the feeding portion, the second radiating portion, the radiating element, and the floating radiation element, and a length of the first signal transmission path is different from a length of the second signal transmission path.
